(19) United States
(12) Patent Application Publication
(10) Pub. No.: US 2007/0236425 A1
(43) Pub. Date: Oct. 11, 2007

(54) Organic light emitting display device

(76) Inventors: Masamitus Furuie, Mobara (JP); Shinichi Kato, Mobara (JP); Masaaki Okunaka, Mobara (JP); Hiroshi Oooka, Mobara (JP); Naoyuki Ito, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/767,007

(22) Filed: Jan. 30, 2004

(30) Foreign Application Priority Data
Jan. 30, 2003 (JP) 2003-022219

(51) Int. Cl. G09G 3/30

(52) U.S. Cl. 345/77

(57) ABSTRACT

In an organic light emitting display device, a plurality of pixel regions are formed two-dimensionally on a transparent substrate, wherein each pixel region includes the multilayered structure which is formed by sequentially stacking a lower transparent electrode, an organic light emitting layer (including at least one organic material layer) and an upper reflection electrode from the transparent substrate side. In such a constitution, at least one concavity which forms a recessed surface with respect to the transparent substrate is formed in the multilayered structure of each pixel region, thus enlarging the effective area of a light emitting portion so as to provide an image display of high brightness with a low current. The concavities are, for example, formed by a plurality of projecting portions on the transparent substrates and by covering the projecting portions with the multilayered structure.

### BACKGROUND OF THE INVENTION

The present invention relates to an organic light emitting display device, and, more particularly, to an organic light emitting display device in which the brightness is enhanced by increasing the utilization efficiency of the emitted light.

Recently, as one example of next-generation flat type display devices, a display device which uses organic light emitting elements has been attracting attention. The display device using organic light emitting elements (hereinafter referred to as an organic light emitting display device) has excellent characteristics, such as a self-luminescent light capability, a wide viewing angle and rapid response characteristics. The structure of the conventional organic light emitting element is constituted of a transparent substrate, which is preferably made of glass; first electrodes made of ITO or the like, which are formed on the transparent substrate; an organic light emitting layer constituted of a hole transporting layer, a light emitting layer and an electron transporting layer and the like, which are stacked on the first electrodes; and second electrodes having a low work function, which are formed on the organic light emitting layer.

By applying a voltage of approximately several V between the first electrode and the second electrode, holes and electrons are respectively injected into the respective electrodes, and they are coupled in the light emitting layer after passing through the hole transporting layer and the electron transporting layer, respectively, thus generating excitons, and light is emitted when these excitons return to a ground state. In a so-called bottom-emission-type organic light emitting display device, which uses a transparent electrode as the first electrode and a reflection electrode as the second electrode, the emitted light passes through the first electrode and is taken out from the transparent substrate side.

FIG. 6 is a cross-sectional view which schematically illustrates an example of an organic light emitting element of one pixel in a bottom-emission type organic light emitting display device. The organic light emitting display element is constituted of a multilayered structural film in which a lower transparent electrode (hereinafter referred to as an anode EA), which constitutes a first electrode and usually becomes an anode, is formed on a transparent substrate SUB, which is preferably made of glass, an organic light emitting layer OLE, which is constituted of a hole transporting layer, a light emitting layer and an electron transporting layer, is stacked over the anode EA, and an upper reflection electrode (hereinafter referred to as a cathode EK), which forms a second electrode and usually becomes a cathode, is stacked over the organic light emitting layer OLE. Here, reference symbols INS1, INS2 indicate insulation layers, and these insulation layers are usually formed of an inorganic insulation material, such as silicon nitride (SIN) or the like. Then, the multilayered structural film is shielded from the environment using a shield plate SB, thus suppressing the degradation of the organic light emitting layer OLE attributed to the intrusion of moisture or the like.

The organic light emitting display device using such an organic light emitting element as a pixel portion is classified into a single-matrix-type organic light emitting display device and an active-matrix-type organic light emitting display device. In the single-matrix-type organic light emitting display device, multilayered structural films, each of which is constituted of a hole transporting layer, a light emitting layer, an electron transporting layer and the like, are formed at positions where a plurality of anode lines (also referred to as anode wiring) and a plurality of cathode lines (also referred to as cathode wiring) intersect each other, and each pixel is turned on or lit only during a selection time within one frame period. The above-mentioned selection time is a time width which is obtained by dividing the one frame period by the number of anode lines. The simple-matrix-type organic light emitting display device has the advantage that the display device has a simple structure.

However, when the number of pixels is increased to provide increased resolution, the selection time is shortened. Accordingly, it is necessary to increase the instantaneous brightness during the selection time by increasing the driving voltage, thus setting the average brightness during one frame period to a given value. In this case, however, there arises a drawback in that the lifetime of the organic light emitting element is shortened. Further, since the organic light emitting element is driven by a current and, hence, particularly with respect to the organic light emitting display device having a large screen, the wiring length of the anode lines and the cathode lines is elongated, a voltage drop attributed to the wiring resistance is generated, whereby the voltage cannot be uniformly applied to the respective pixels. As a result, in-plane brightness irregularities occur in the display device. For these reasons, there exists a limit with respect to the achievable high definition and the screen provided in the single-matrix-type organic light emitting display device.

On the other hand, the active-matrix-type organic light emitting display device has a structure in which a pixel drive circuit, which is constituted of two to four active elements, such as thin film transistors or the like, and a capacitance, is connected to the organic light emitting element which constitutes each pixel; and, further, a power source line which supplies an electric current to the organic light emitting element is provided, thus enabling the lighting of all pixels within one frame period. Accordingly, it is not necessary to increase the brightness, and, hence, the lifetime of the organic light emitting element can be prolonged. For such reasons, it is considered that the active matrix-type organic light emitting display device is advantageous with respect to the ability to achieve a high definition and large-sizing of the display screen. Although the explanation will be directed to use of a thin film transistor as the active element hereinafter, it is needless to say that other active elements can be used.

As mentioned previously, the active-matrix-type organic light emitting display device of a type which takes out emitted light from the transparent substrate side is also referred to as a bottom-emission-type organic light emitting display device. In the organic light emitting display device of this type, when the pixel drive circuit is provided between the transparent substrate and the multilayered structural film, which constitutes the organic light emitting element, the pixel drive circuit interrupts or blocks the emitted light of the organic light emitting element, and, hence, the so-called numerical aperture is limited. Particularly, when the display device has a large screen, to reduce the brightness irregularities between the pixels attributed to the voltage drop between power source lines, it is necessary to increase the width of the power source lines, and, hence, the numerical aperture becomes small. Further, when an attempt is made to increase the capacitances for holding a bias voltage and a signal voltage of the thin film transistor which drives the organic light emitting element, the area of the capacitance electrode is increased, and, hence, the numerical aperture is decreased. Further, in the conventional organic light emitting display device, the utilization efficiency of light emitted from the light emitting layer is insufficient, and, hence, it is difficult to produce a high brightness.

The following patent publication is referred to in connection with related display devices:

Patent Document 1: Japanese Unexamined Patent Publication 1998-208875.

### SUMMARY OF THE INVENTION

FIG. 7 is an enlarged view of the portion indicated by an arrow A in FIG. 6, which illustrates an irradiation state of an emitted light in an organic light emitting element which constitutes an conventional organic light emitting display device. In FIG. 7, the multilayered structural film, which is constituted of the lower transparent electrode (anode EA), the organic light emitting layer OLE and the upper reflection electrode (cathode EK) and is formed on the transparent substrate SUB, is formed so as to provide a planer surface parallel to the surface of the transparent substrate SUB. That is, with respect to the light emitted from a point P of the organic light emitting layer OLE in FIG. 7, a light component Lm, which is directly irradiated from the point P through the transparent substrate SUB, and a light component Lr, which is reflected on the upper reflection electrode EK and [asses through the transparent substrate SUB, are used for the display. However, a light component Lf, which is irradiated in a direction parallel (including “approximately parallel”, applicable to the description made hereinafter in the same manner) to the transparent substrate SUB, is not available for the display and is wasted.

Since the organic light emitting layer OLE in the pixel portion is parallel to the surface of the transparent substrate SUB, the light emitting area is defined by the area of the pixel portion, whereby it is necessary to increase the current quantity in order to increase the brightness of the emitted light of the organic light emitting layer OLE. However, when the current quantity is increased, a degeneration of the organic material, which constitutes the multilayered structural film, attributed to an electrochemical reaction, is promoted, thus shortening the lifetime of the multilayered structural film.

To increase the area of the organic light emitting layer OLE, as described in the “patent document 1”, there has been proposed a technique in which the surface of the transparent substrate is formed in a convex shape by using a solvent. However, in the “patent document 1”, in a dissolving step of the substrate forming process in which the solvent is used, there exists a possibility that the organic light emitting layer will become contaminated, and, hence, it is difficult to ensure the reliability of the organic light emitting layer.

Accordingly, it is an object of the present invention to provide an organic light emitting display device using low current organic light emitting elements with which high brightness can be realized by a structure in which the area of the light emitting portion made of an organic light emitting layer is larger than the area of the pixel portion, thus enlarging the effective area of the light emitting portion, and the light from the organic light emitting layer is effectively taken out to the transparent substrate side.

To achieve the above-mentioned object, the organic light emitting display device according to the present invention is characterized by a structure in which, in a multilayered structural film of an organic light emitting element thereof, which is constituted by sandwiching an organic light emitting layer between a lower transparent electrode and an upper reflection electrode, one or a plurality of concavities (for example, at least a portion of an interface between the lower transparent electrode and the organic light emitting layer forming a concave surface with respect to the transparent substrate) are formed, and an organic insulation film is filled in the concavities. That is, with respect to the organic light emitting element which constitutes the organic light emitting display device of the present invention, a plurality of pixel portions, which are constituted of organic light emitting elements arranged in a matrix array on the transparent substrate, and pixel drive circuits, which have active elements, such as thin film transistors, for driving the organic light emitting elements, are formed in a matrix array. In other words, in a plurality of respective pixel regions formed in the organic light emitting display device, at least one concave lens is formed in a light emitting surface of the organic light emitting layer facing the transparent substrate (for example, an interface between the lower transparent electrode and the organic light emitting layer). The concave lens is formed so as to be housed in the inside of an opening of a bank portion of an insulation layer which partitions a plurality of pixel regions.

The above-mentioned organic light emitting element is configured such that the organic light emitting element includes a large number of light emitting regions arranged in a matrix array, wherein each light emitting region constitutes a pixel portion for each pixel unit formed of a multilayered structural film, which is constituted of a lower transparent electrode formed at the transparent substrate side, the organic light emitting layer, and an upper reflection electrode formed above the organic light emitting layer, and light emitted from the organic light emitting layer is taken out from the lower transparent electrode side through the transparent substrate. Further, the above-mentioned multilayered structural film has concavities which are recessed at the transparent substrate side in the inside of the pixel portion and a plurality of projecting portions which project at a side opposite to the transparent substrate. A transparent organic insulation layer is arranged between the above-mentioned concavities of the projecting portions and the transparent substrate.

By forming the concavities to have a shape such that the concavities have open peripheries at the transparent substrate side and have a cross section along a surface perpendicular to the transparent substrate which has a bowl shape or a shape similar to a bowl shape (a turned-over bowl shape, for example, a bowl shape having elliptical, polygonal or irregular open peripheries, hereinafter referred to as a bowl shape including these shapes), the light emitting area can be made larger than the area of the pixel portion. Further, the emitted light from the organic light emitting layer which constitutes the multilayered structural film can, besides the light which is directly irradiated in a direction toward the transparent substrate, also direct the light which is reflected on an inner surface of the bowl-shaped upper reflection electrode in a direction toward the transparent substrate. Further, the shape of the concavities may be formed such that the concavities have oblique surfaces which are gradually enlarged and opened from the peripheries of a flat center portion toward the transparent substrate side, thus forming a cross section along a surface perpendicular to the transparent substrate which has a trapezoidal shape or a shape similar to a trapezoidal shape (hereinafter referred to as a trapezoidal shape including these shapes). In this manner, by forming the shape of the concavities into a combined shape of a bowl shape and a trapezoidal shape, the emitted light from the organic light emitting layer which constitutes the multilayered structural film can, besides the light which is directly irradiated in a direction toward the transparent substrate, also direct the light which is reflected on an inner surface of the upper reflection electrode having the trapezoidal shape or combined shape of the bowl shape and the trapezoidal shape in a direction toward the transparent substrate.

Further, by forming the transparent-substrate-side end peripheries of the concavities such that such end peripheries do not extend beyond the end peripheries of the light emitting region of the pixel portion, it is possible to prevent leaking of light in a direction parallel to the transparent substrate from the open peripheries and oblique surfaces of the concavities, and, hence, substantially all of the emitted light can be taken out in the transparent substrate direction, whereby the utilization efficiency of the emitted light can be enhanced.

Accordingly, the light emitting area of the pixel portion can be substantially enlarged, and, hence, emitted light having a high brightness can be taken out from the transparent substrate side with a low electric current, whereby a long lifetime can be ensured by suppressing an electrochemical reaction of the organic light emitting layer which is caused by an increase of the electric current quantity required for obtaining a high brightness in the conventional structure.

Here, it is needless to say that the present invention is not limited to the above-mentioned constitutions and constitutions which will be explained in conjunction with embodiments to be described later, and various modifications are conceivable without departing from the technical concept of the present invention.

### BRIEF DESCRIPTION OF THE DRAWINGS

FIG. 1 is a plan view in the vicinity of one pixel of an organic light emitting element constituting an organic light emitting display device representing a first embodiment of the present invention;

FIG. 2 is a cross-sectional view taken along a line A-A′ in FIG. 1;

FIG. 3 is an enlarged cross-sectional view illustrating the irradiation of emitted light from the organic light emitting layer at one projecting portion in FIG. 2;

FIG. 4 is a cross-sectional view similar to FIG. 3 showing a portion in the vicinity of one pixel of the organic light emitting element constituting the organic light emitting display device according to a second embodiment of the present invention;

FIG. 5 is an equivalent circuit diagram of one pixel of the organic light emitting element to which the present invention is applied;

FIG. 6 is a cross-sectional view which schematically shows an example of the structure of an organic light emitting element of one pixel constituting a bottom-emission-type organic light emitting display device; and

FIG. 7 is an enlarged view of a portion indicated by an arrow A in FIG. 6 showing an irradiation state of emitted light in an organic light emitting element which constitutes a conventional organic light emitting display device.

### DETAILED DESCRIPTION

Various embodiments of an organic light emitting display device according to the present invention will be explained in detail in conjunction with the drawings.

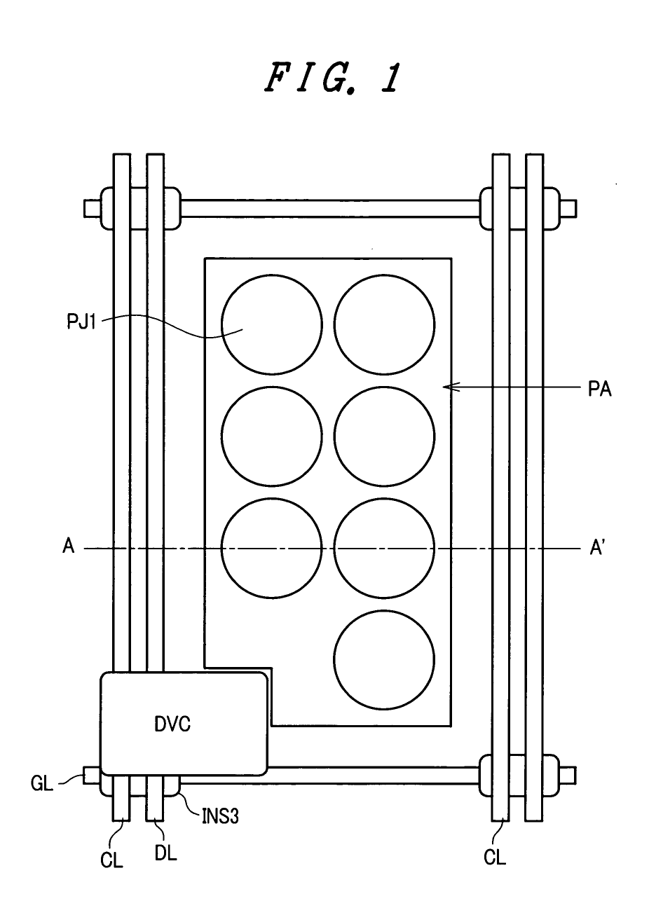

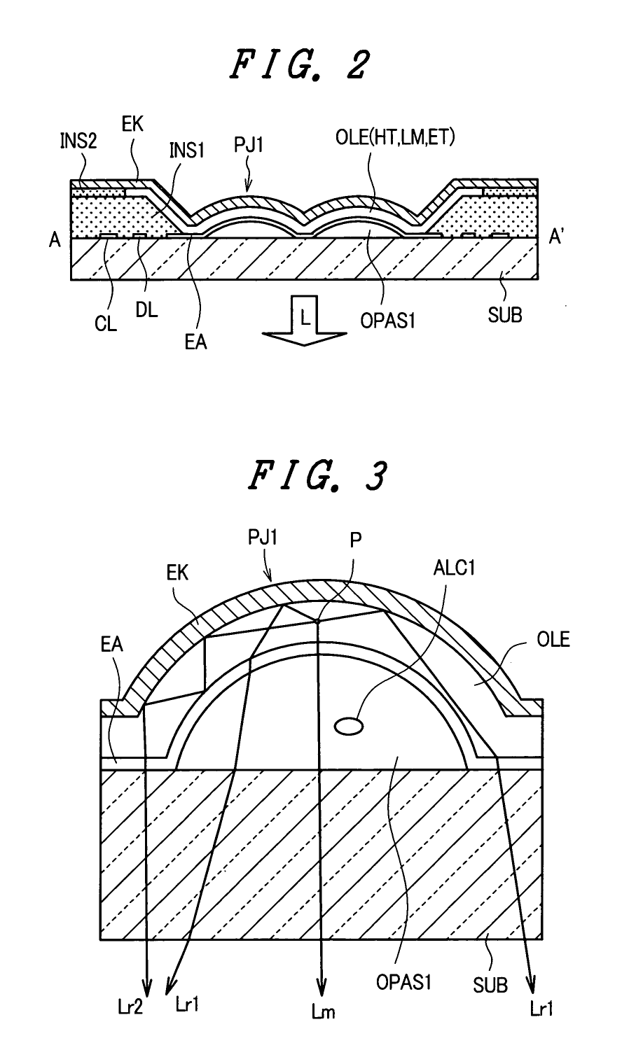

FIG. 1 is a plan view in the vicinity of one pixel of an organic light emitting element which constitutes an organic light emitting display device representing a first embodiment of the present invention. Further, FIG. 2 is a cross-sectional view taken along a line A-A′ in FIG. 1. The organic light emitting display element of this embodiment includes a plurality of bulging portions OPAS1 disposed on a transparent substrate SUB, as shown in a cross-section in FIG. 2. These bulging portions OPAS1 are formed of a transparent organic insulation layer. Further, a first electrode (an anode in this embodiment, hereinafter referred to as an anode EA), which constitutes a pixel portion PA, is formed to cover the bulging portions OPAS1. An organic light emitting layer OLE is formed over the anode EA. Further, a second electrode (a cathode in this embodiment, hereinafter referred to as a cathode EK) is formed over the organic light emitting layer OLE by stacking. The organic light emitting layer OLE is basically constituted such that a hole transporting layer HT, a light emitting layer LM and an electron transporting layer ET are stacked from the anode EA side toward the cathode EK side.

In FIG. 2, reference symbols INS1, INS2 indicate insulation layers. These insulation layers INS1, INS2 are usually formed of an inorganic insulation material, such as silicon nitride (SiN), and they ensure the insulation of data signal lines DL, scanning signal lines GL and power source lines CL, as well as the insulation of anodes EA and the cathodes EK; and, at the same time, they constitute banks for defining boundaries between neighboring pixels at the peripheries of the pixel portions PA. Further, reference symbol INS3 in FIG. 1 indicates an insulation layer at an intersecting portion of the scanning signal line GL, the data signal line DL and the power source line CL. Emitted light L from the organic light emitting layer OLE is taken out from the transparent substrate SUB in the direction indicated by the large arrow L.

As can be understood from the plane shape shown in FIG. 1, a multilayered structural film constituted of the anode EA, the organic light emitting layer OLE and the cathode EK has a shape which traces the surface shape of the above-mentioned bulging portion OPAS1 in the inside of the pixel portion PA. In this embodiment, in the inside of the region of the pixel portion PA, the multilayered structural film has concavities PJ1 (also shown in FIG. 3 with a reference symbol ALC1) which are recessed at the transparent substrate SUB side, wherein a plurality (seven) of bowl-shaped projecting portions PJ1 having a turned-over bowl-shape projected to a side opposite to the transparent substrate SUB are formed. In this embodiment, one pixel is formed in a region which is surrounded by the data signal line DL, which extends in one direction, the scanning signal line GL, which extends in another direction crossing the one direction, and the power source line CL, which is arranged parallel to the data signal line DL and extends close to the data signal line DL. At a corner of the pixel portion PA, a pixel drive circuit DVC which is constituted of a thin film transistor is provided.

FIG. 3 is a cross-sectional view which illustrates the irradiation of the emitted light from the organic light emitting layer at one projecting portion shown in FIG. 2. The projecting portion PJ1 of this embodiment is constituted of the bulging portion OPAS1 having a bowl shape and is made of a transparent organic insulation material, which is disposed in the concavity ALC1 having the bowl shape of the multilayered structural film that is formed of the anode EA, the organic light emitting layer OLE and the cathode EK. The emitted light from one point P of the organic light emitting layer OLE includes a direct light component Lm, which is directly irradiated from the point P through the transparent substrate SUB, a reflection light component Lr1, which is irradiated through the transparent substrate SUB after being reflected on the cathode EK, which constitutes an upper reflection electrode, and a multiple reflection light component Lr2, which is irradiated from the transparent substrate SUB after being reflected multiple times on the cathode EK and the anode EA, which constitutes a lower transparent electrode. In this manner, substantially all of the emitted light from the one point P of the organic light emitting layer OLE passes out through the transparent substrate SUB (absorption of the emitted light by the multilayered structural film, the bulging portion OPAS1 or the transparent substrate SUB is not considered. The same is applicable to the description provided hereinafter).

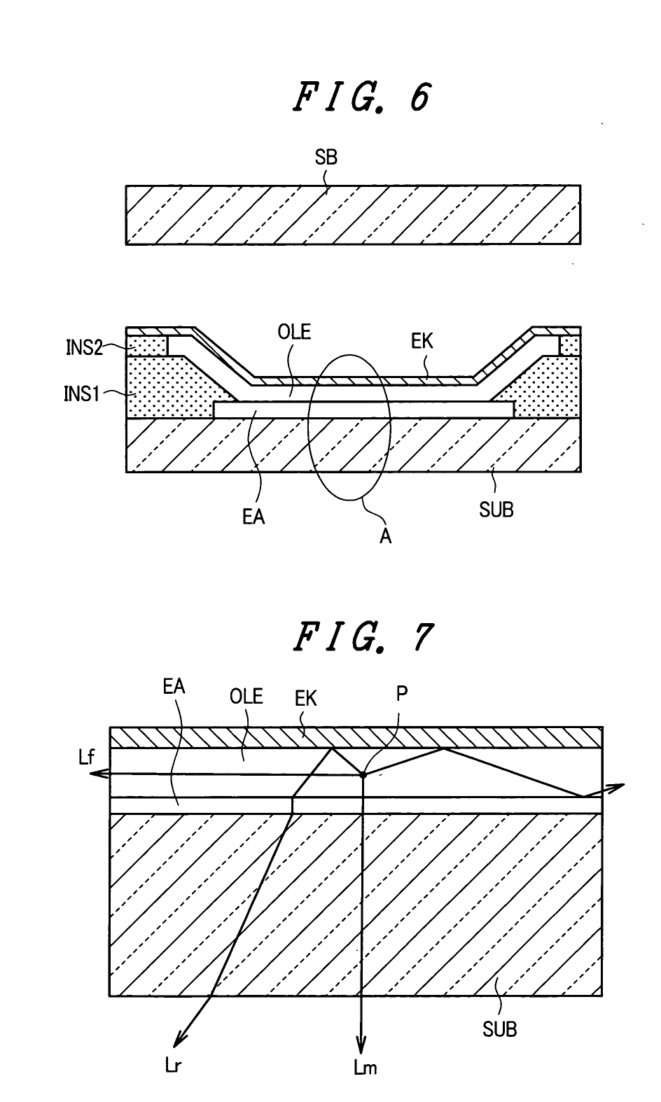

Further, as can be clearly understood from the drawing, the area of the organic light emitting portion, which is formed between the concavity ALC1 and the projecting portion PJ1, is broadened compared to the area of the conventional light emitting portion described previously in conjunction with FIG. 6 and FIG. 7, in which the multilayered structural film of the organic light emitting portion has a planer shape parallel to the surface of the transparent substrate SUB. Accordingly, the area which contributes to the emission of light is substantially enlarged. That is, although the area of the pixel portion PA as seen in plan view may be equal, the effective light emitting area is enlarged, and, hence, the light emitting quantity of one pixel is increased. Here, although a single projecting portion PJ1 having the concavity ALC1 may be formed in the inside of the pixel, it is preferable to provide a plurality of projecting portions PJ1. Particularly, to prevent degeneration of the organic light emitting layer OLE caused by undesired substances, such as moisture from the organic insulation layer which is formed to fill the concavity ALC1 of the bowl-shaped bulging portion OPAS1, it is preferable to form a plurality of small projecting portions PJ1 and to cover these projecting portions PJ1 with the anode EA made of ITO.

In this manner, according to this embodiment, the multilayered structural film, which is constituted of the anode EA, the organic light emitting layer OLE and the cathode EK and which is formed over the organic light emitting layer OLE, is formed such that a plurality of bowl-shaped projecting portions PJ1, which project to the side opposite to the transparent substrate SUB, while providing a concavity ALC1, which is recessed toward the transparent substrate SUB side, are formed in the inside of the pixel portion PA, and the transparent organic insulation material is filled in the bowl-shaped bulging portion OPAS1 defined between the concavity ALC1 of the projecting portion PJ1 and the transparent substrate SUB. As a result, the quantity of light taken out from the organic light emitting layer OLE can be increased, so that it is possible to acquire a high brightness without increasing the current quantity, compared to the conventional structure shown in FIG. 6 and FIG. 7.

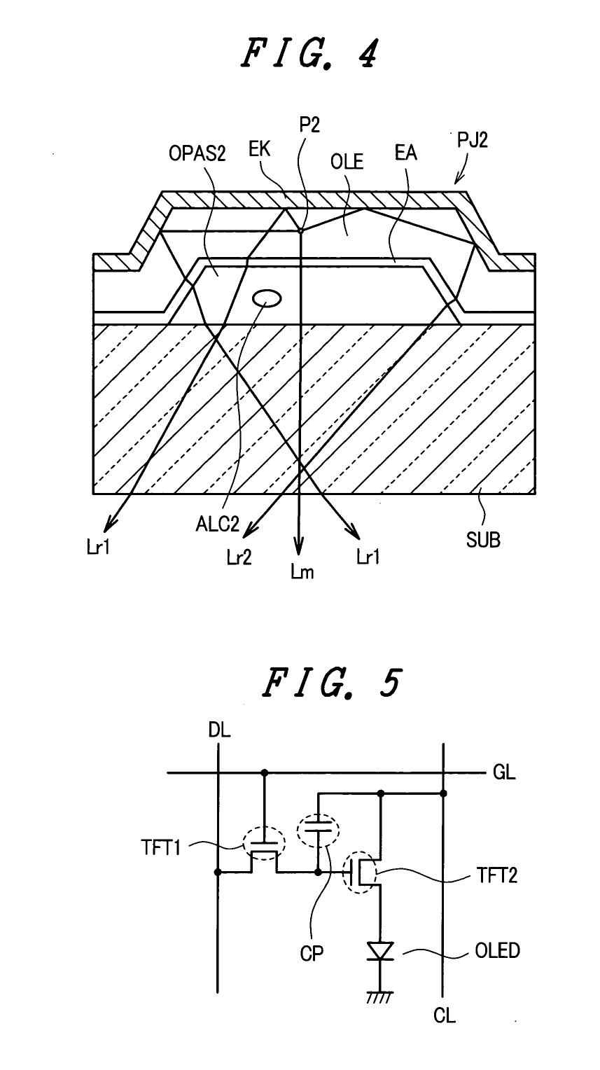

FIG. 4 is a cross-sectional view similar to FIG. 3 showing the vicinity of one pixel of the organic light emitting element constituting an organic light emitting display device according to a second embodiment of the present invention. The planar constitution of the pixel in this embodiment is substantially the same as the planer shape of the pixel shown in FIG. 1, except for the shape of the projecting portion PJ2, which has a trapezoidal shape, and in which the cross-section thereof perpendicular to the transparent substrate SUB shows a concavity ALC2 formed in the pixel portion that opens at the substrate side, and the shape of the bulging portion OPAS2 has a trapezoidal shape in which the cross-section thereof corresponds to the shape of the cross-section of the projecting portion PJ2. That is, in this embodiment, the shape of the concavity ALC2 of the projecting portion PJ2, which opens toward the transparent substrate SUB side, has a flat portion at the center portion of the bottom surface of the concavity ALC2 and oblique surfaces which gradually enlarged toward the transparent substrate SUB side from the peripheries of the center portion, thus making the cross section perpendicular to the transparent substrate SUB have a trapezoidal shape.

The trapezoidal projecting portion PJ2 of this embodiment is formed of a multilayered structural film consisting of an anode EA, an organic light emitting layer OLE and a cathode EK, which are stacked on the bulging portion OPAS2 of transparent organic insulation material which is disposed in the concavity ALC2 having a trapezoidal cross section. In FIG. 4, the emitted light from one point P of the organic light emitting layer OLE includes a direct light component Lm, which directly passes from the point P through the transparent substrate SUB, a reflection light component Lr1, which passes through the transparent substrate SUB after being reflected on the cathode EK, which constitutes an upper reflection electrode, and a multiple reflection light component Lr2, which passes through the transparent substrate SUB after being reflected multiple times on the cathode EK and the anode EA, which constitutes a lower transparent electrode. In this manner, substantially all of the emitted light from the point P of the organic light emitting layer OLE passes out through the transparent substrate SUB.

Further, as can be clearly understood from FIG. 4, the area of the multilayered structural film, which constitutes a light emitting layer of the pixel and which is formed of the concavity ALC2 and the trapezoidal projecting portion PJ2, is broadened compared to the area of the conventional light emitting portion described in conjunction with FIG. 6 and FIG. 7, in which the multilayered structural film of the pixel has a planer shape parallel to the surface of the transparent substrate SUB. Accordingly, the area which contributes to the emission of light is substantially enlarged. That is, although the area of the pixel portion PA as seen in plan view may be equal, the effective light emitting area is enlarged. Here, although a single trapezoidal projecting portion PJ2 having the concavity ALC2 may be formed in the inside of the pixel, it is preferable to provide a plurality of projecting portions PJ2 to achieve uniformity of the brightness in the inside of the pixel. Particularly, to prevent the degeneration of the organic light emitting layer OLE caused by undesired substances, such as moisture from the organic insulation layer which is formed in the concavity ALC2 of the trapezoidal bulging portion OPAS2, it is preferable to form a plurality of trapezoidal projecting portions PJ2 having a small planer area and to cover these projecting portions PJ2 with the anode EA made of ITO.

In this manner, according to this embodiment, the multilayered structural film, which is constituted of the anode EA, the organic light emitting layer OLE and the cathode EK and which is formed over the organic light emitting layer OLE, is formed such that a plurality of trapezoidal projecting portions PJ2, which project to the side opposite to the transparent substrate SUB, while providing a concavity ALC2 of the trapezoidal bulging portion OPAS2 which is formed to be recessed toward the transparent substrate SUB side, are formed in the inside of the pixel portion PA, and the transparent organic insulation layer OPAS2 is filled in between the concavity ALC2 of the projecting portion PJ2 and the transparent substrate SUB. As a result, the quantity of light taken out from the organic light emitting layer OLE can be increased and the liquid crystal display device so that it is possible to acquire a high brightness without increasing the current quantity, compared to the conventional structure shown in FIG. 6 and FIG. 7.

The shape of the concavity which can be used in accordance with the present invention is not limited to the shapes which are indicated in the above-mentioned respective embodiments. For example, the cathode EK may be configured so as to have a triangular shape, a polygonal shape, a conical shape or an elliptical-conical shape, which opens toward the transparent substrate SUB side, or a shape which reflects the emitted light of the organic light emitting layer toward the transparent substrate SUB, and has a transparent insulation material in the concavity thereof. Such a cathode EK can obtain an advantageous effect similar to those of the respective embodiments.

The transparent organic insulation material, which is formed to fill the above-mentioned concavity, may be formed using an organic PAS film manufacturing process typical of thin film transistor manufacture, having a low-temperature polycrystal silicon channel. That is, using the transparent organic insulation material, the bulging portions (OPAS1, OPAS2) having a desired size are formed with high accuracy in such a manner that a solution of an organic material, such as an acrylic resin or the like, for example, is applied to the transparent substrate SUB2 as the organic material by spin coating or the like, and, thereafter, it is subjected to pre-baking, mask exposure, development and post-development-baking (decolorization baking: post-baking). ITO is formed over the bulging portions OPAS1, OPAS2 to serve as the anode EA, and the organic light emitting layer OLE is formed over the anode EA, and the cathode EK is formed as an uppermost layer.

As a specific example of the above-mentioned organic material, an organic material which is disclosed in Japanese Patent Publication 2893875 or a radiation-sensitive (photosensitive) material as disclosed in Japanese unexamined patent publication 2000-131846 can be used. Further, in forming the bowl-shaped bulging portions similar to those described in conjunction with the first embodiment of the present invention, the above-mentioned organic material is applied to the transparent substrate, a mask having a large number of openings corresponding to the above-mentioned bulging portions is arranged on the applied film with a given distance therebetween, and ultraviolet rays are irradiated by way of the mask. As a result, a gradient is generated in the intensity of the ultraviolet rays irradiated to the applied film, and, hence, a bridging reaction is gradually weakened from the center portion to the periphery of each opening of the mask, whereby bowl-shaped bulging portions having smooth surfaces can be formed.

Further, the trapezoidal bulging portion employed in the second embodiment of the present invention can be formed by either increasing the open area of the mask or increasing the distance between the mask and the applied film. In this manner, the bulging portion made of the transparent organic insulation material in accordance with the present invention is formed prior to the film formation of the organic light emitting layer; and, hence, there is no possibility that the process for forming the bulging portion influences the material of the organic light emitting layer, whereby the above-mentioned degeneration of the organic light emitting layer in the conventional example can be eliminated.

FIG. 5 is an equivalent circuit diagram of one pixel of the organic light emitting element to which the present invention is applied. In FIG. 5, reference symbol GL indicates the scanning signal line, reference symbol DL indicates the data signal line and reference symbol CL indicates the power source line. In this circuit, the pixel is constituted of a first thin film transistor TFT 1 which is connected to the scanning signal line GL and the data signal line DL, a second thin film transistor TFT2 which is connected to the power source line CL and the organic light emitting element OLED, and a capacitance CP which is charged through the power source line CL. A pixel drive circuit is constituted of the first thin film transistor TFT1, the second thin film transistor TFT 2 and the capacitance CP.

The first thin film transistor TFT1, which is selected by the scanning signal line GL, charges the capacitance CP in response to signal data applied thereto from the data signal line DL. An electric current is made to flow into the second thin film transistor TFT2 from the power source line CL in response to the charge quantity of the signal data charged in the capacitance CP, and a light is emitted corresponding to an inflow current value. A plurality of these pixels are arranged in a matrix array, thus constituting a planar display element. The organic light emitting display device is constituted by incorporating a display control circuit which controls a pixel drive circuit and the like in the periphery of the display element.

The use of the organic light emitting display device of the present invention is not limited to a mobile phone or a portable information terminal (Personal Digital Assistants, i.e. PDA). That is, the organic light emitting display device also can be used as a display device of a personal computer, various monitors or a television receiver set.

As has been explained heretofore, according to the present invention, it is possible to enlarge the effective light emitting area by the area of the light emitting portion (pixel) of the organic light emitting layer so that it is larger than the area of the pixel region; and, at the same time, it is possible to effectively take out the light emitted from the light emitting layer to the transparent substrate side, whereby it is possible to provide an organic light emitting display device using an organic light emitting element which can exhibit high brightness with a low current.

1. An organic light emitting display device in which a plurality of pixel portions which are constituted of the organic light emitting elements which are arranged in a matrix array on the transparent substrate and pixel drive circuits which have active elements for driving the organic light emitting elements are formed in a matrix array, wherein
an organic light emitting element includes a light emitting region formed of a multilayered structural film which is constituted of a lower transparent electrode formed at the transparent substrate side, an organic light emitting layer, and an upper reflection electrode formed above the organic light emitting layer, the organic light emitting element being configured to emit light of the organic light emitting layer from the lower transparent electrode side through the transparent substrate,
the multilayered structural film has concavities which are recessed at the transparent substrate side in the inside of the pixel portion and projecting portions which project at a side opposite to the transparent substrate, and
a transparent organic insulation layer is arranged between in the concavities of the projecting portions.

2. An organic light emitting display device according to claim 1, wherein the shape of the concavities is such that the concavities have open peripheries at the transparent substrate side and have a cross section along a surface perpendicular to the transparent substrate which has a bowl shape.

3. An organic light emitting display device according to claim 1, wherein the shape of the concavities is such that the concavities have oblique surfaces which are gradually enlarged and opened toward the transparent substrate side from peripheries of a flat center portion, thus forming a cross section along a surface perpendicular to the transparent substrate which has a trapezoidal shape.

4. An organic light emitting display device according to claim 2, wherein transparent-substrate-side end peripheries of the concavities are formed such that the end peripheries do not extend beyond end peripheries of the light emitting region of the pixel portion.

5. An organic light emitting display device according to claim 1, wherein a plurality of projecting portions having the concavities are arranged in parallel within a pixel portion.

6. An organic light emitting display device according to claim 1, wherein the active element is a thin film transistor having a low-temperature polycrystalline silicon channel.
